(19) United States
(12) Patent Application Publication
(10) Pub. No.: US 2007/0282671 A1
(43) Pub. Date: Dec. 6, 2007

(54) System and method for generating a chain-weighted equipment price index

(75) Inventors: Michael J. Athey, Washington, IL (US); Wende D. Reeser, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/806,430

(22) Filed: May 31, 2007

Related U.S. Application Data
(60) Provisional application No. 60/809,400, filed on May 31, 2006.

(51) Int. Cl. G06F 17/30; G07G 1/00

(52) U.S. Cl. 705/10

(57) ABSTRACT

Systems and methods are disclosed that generate a chain-weighted equipment price index. In one embodiment, the equipment price management system may receive equipment sales records and store the sales records in a database. A user of the system may request that an equipment price index be generated for a set of time periods, including a first time period and a second time period. The index may reflect the price performance of one or more types of equipment. Based on the equipment sales records, the equipment price management system may then determine a first equipment quantity for the first time period and a second equipment quantity for the second time period. The equipment management system may determine a first median price of the first equipment quantity for the first time period and a second median price of the second equipment quantity for the second time period. The equipment price management system may then determine the equipment price index based on the first and second equipment quantities and the first and the second median prices. The equipment price index is provided to help the user perform business assessments related to equipment associated with the equipment sales records.

### TECHNICAL FIELD

The present disclosure relates generally to data processing, and more particularly to systems and methods for generating a chain-weighted equipment price index using market transaction data.

### BACKGROUND

A price index can be used to track changes in prices of various goods and services purchased or sold. An equipment price index may provide monthly, quarterly, yearly, or higher frequency estimates of price changes for equipment purchases. The equipment price index may be used by equipment market participants (manufacturers, dealers, and the like) to assess the relative state of the equipment market. As a market indicator, the equipment price index provides information on the capital input to manufacturers, dealers, and the like. The equipment price index may be organized from an industry, manufacturer, or distributor perspective, as well as other aggregations. In addition, the equipment price index may track the price movements in specific geographic markets.

An equipment price index may be a weighted index. The equipment price data, as well as the type of algorithm used for weight calculations, significantly affect whether an equipment price index can serve as a true measurement of equipment price performance in a market. Conventional methods and systems for generating equipment price indexes gather equipment price data from surveys and statistical agencies. Traditionally, the weights are often calculated based on a market basket from a base year. As such, the equipment price index calculation is subject to the errors in equipment price data and the over/under bias by the base year data.

The accuracy of survey data may be affected by the structure of the surveys, the methodology used to conduct the surveys, and the respondents' ability to enter accurate input. In most statistical analysis, such as the process to generate an equipment price index, quality of data is a major issue. Traditional equipment price indexes are often based on incomplete survey data from dealers, purchasing managers, and manufacturers. Inaccurate survey data, as well as outlier sales price data points, often skew the index.

One conventional approach to determining the weight of a weighted equipment price index is to use a fixed weight to calculate an equipment price index. For example, the quantity of a base time period, such as a base year, would be used as the weight to calculate the equipment price index for all other time periods. The fixed weighted equipment price index would therefore reflect the price changes in view of the base time period, such as the base year. When a user requests an equipment price index using a different base time period, the fixed weighted equipment price index needs to be recalculated using the new fixed weight.

Another conventional approach to determining the weight of a weighted price index is to compose a selected set of components to derive a weight to be used for each price point. A well-known example is the Standard & Poor's 500®, which is an index made up of 500 blue chip stocks. Another example is disclosed in U.S. patent application Ser. No. 10/317,557 to Speth, filed on Dec. 11, 2002, relating to a method for creating a share-weighted index that is intended to replicate the investment return of a “buy-and-hold” portfolio of assets. The Speth application also discloses a method of trading derivative investment products based on such an index. The components of the share-weighted index are selected to reflect the index designer's desired investment exposure. The weight of each component is determined by the component's price multiplied by an adjustment factor. The adjustment factor is chosen to yield an initial index weight deemed appropriate by the designer of the index. The weighted prices of all components are then added together and divided by a common divisor.

While conventional methods and systems may be effective to some extent for estimating and measuring equipment prices, they are often overly biased by certain factors. For example, these systems tend to be sensitive to outlier data observations. An outlier data point is a single observation “far away” from the rest of the data. In most samplings of data, some data points will be further away from their expected values than what is deemed reasonable. Such outlier data points can indicate faulty data, erroneous procedures, or areas where a certain theory might not be valid, although some outliers are expected in normal distributions. For example, factors such as the state of the economy and seasonal demand of certain industries may cause changes in equipment sales and transaction prices. Conventional systems use mean prices to estimate equipment market performance and, therefore, may be overly biased by outlier equipment prices. Additionally, conventional methods and systems do not take into account changing equipment sales volumes (i.e., quantities) when generating an equipment price index.

Therefore, there is a need to provide an equipment price index reflecting the relative market transaction price performance of the equipment while taking into consideration the potential for incomplete and unbalanced data samples. Moreover, there is a need to provide an equipment price index that does not require revision when the base time period is changed. The disclosed embodiments improve upon prior art systems by providing a more accurate equipment price index reflecting the performance of the actual equipment market.

### SUMMARY OF THE INVENTION

It is to be understood that both the foregoing general description and the following detailed description are exemplary and explanatory only, and are not restrictive of the claimed embodiments.

Systems and methods are disclosed that generate a chain-weighted equipment price index. In one embodiment, the equipment price management system may receive equipment sales records and store the sales records in a database. A user of the system may request that an equipment price index be generated for a set of time periods, including a first time period and a second time period. The index may reflect the price performance of one or more types of equipment. Based on the equipment sales records, the equipment price management system may then determine a first equipment quantity for the first time period and a second equipment quantity for the second time period. The equipment price management system may determine a first median price of the first equipment quantity for the first time period and a second median price of the second equipment quantity for the second time period. The equipment price management system may then determine the equipment price index based on the first and second equipment quantities and the first and the second median prices. The equipment price index is provided to help the user perform business assessments related to equipment associated with the equipment sales records.

### BRIEF DESCRIPTION OF THE DRAWINGS

The accompanying drawings, which are incorporated in and constitute a part of this specification, illustrate exemplary embodiments of the invention and, together with the description, serve to explain the disclosed embodiments. In the drawings:

FIG. 1 is a block diagram of an exemplary equipment price management environment consistent with certain embodiments of the present disclosure;

FIG. 2 is a flow chart of exemplary steps to generate an equipment price index consistent with certain embodiments of the present disclosure;

FIG. 3A is an exemplary data table used in generating an equipment price index consistent with certain embodiments of the present disclosure;

FIG. 3B is another exemplary data table used in generating an equipment price index consistent with certain embodiments of the present disclosure;

FIG. 3C is another exemplary data table used in generating an equipment price index consistent with certain embodiments of the present disclosure;

FIG. 3D is another exemplary data table used in generating an equipment price index consistent with certain embodiments of the present disclosure; and

FIG. 3E is an exemplary equipment price index graph consistent with certain embodiments of the present disclosure.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

In this disclosure, the term “equipment” generally refers to any type of machine, vehicle, or any other type of asset. The term “equipment price index” refers to either a singular equipment price index data point in a given time period, or an equipment price index over multiple time periods.

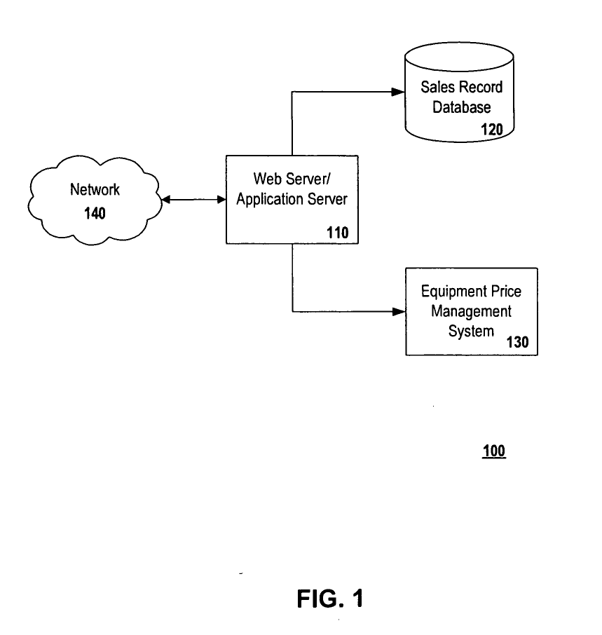

FIG. 1 is a block diagram illustrating an exemplary equipment price management environment 100. Equipment price management environment 100 may include a web server/application server module 110, a sales record database 120, an equipment price management system 130, and a network 140. Web server/application server module 110 interfaces with network 140. Web server/application server module 110 is also connected to sales record database 120 and equipment price management system 130. It is contemplated that equipment price management environment 100 may include some, all, or additional components illustrated in FIG. 1.

Web server/application server module 110 may include an interface device (e.g., graphical user interface) for a user to access sales record database 120 and/or equipment price management system 130. A user of equipment price management environment 100 may manage equipment prices by requesting an equipment price index through web server/application server module 110. An equipment price index may be a data structure including data reflecting how the market price of one or more pieces of equipment changes over multiple time periods. For example, an equipment price index may show that equipment A's market price fluctuates over a few years (i.e., increasing or decreasing in a given year relative to a previous year).

Further, web server/application server module 110 may include additional software/hardware components, such as collaboration tools that permit users of equipment price management environment 100 to share data and information, to work together, bulletin boards to permit users to communicate with each other, and/or search engines to provide efficient access to specific entries in sales record database 120 or equipment price management system 130. One or more memory devices, such as memory devices implemented within web server/application server module 110 may also permit users of equipment price management environment 100 to submit records to be added to sales record database 120. As such, web server/application server module 110 may include one or more software and/or hardware components that enable a user or software process to manage information contained in equipment price management environment 100. Web server/application server module 110 may include any type of web server and/or application server software, such as the Apache HTTP Server from the Apache Software Foundation.

Sales record database 120 may be a system including one or more memory devices and software executed by a processor that is configured to store sales records, charts, entries for changes made to the records, and other information used by users of equipment price management environment 100. A sales record may be any type of new and/or used equipment sales transaction record, such as a retail sales record, an auction sales record, and the like. Equipment price management environment 100 may include one or more sales record databases 120.

In one embodiment, sales record database 120 may include auction sales data records for new and/or used equipment. An auction sales data record may include transactional information for a piece of equipment sold at auction, such as the make, model, age, and price of a machine. Sales record database 120 may also include data used in calculating an equipment price index, such as a relative equipment price measurement in a given time period, and charts of equipment price indexes, etc. A relative equipment price measurement refers to a data point of the equipment price index corresponding to a specific time period. The equipment price index may include one or more equipment price index data points. For example, a yearly equipment price index for equipment A may include an equipment price index data point for the year 2000, another equipment price index data point for the year 2001, etc.

Equipment price management system 130 may be a computer system or software executed by a processor that is configured to provide access to sales records stored in sales records database 120. Equipment price management system 130 may receive requests from a user of equipment price management environment 100 through web server/application server 110. Equipment price management system 130 may access data records stored in sales record database 120 to perform the calculations to generate equipment price indexes as requested by the user. Equipment price management system 130 may also present a requested equipment price index to the user through web server/application server module 110.

In one embodiment, equipment price management system 130 may generate an equipment price index based on auction sales data records stored in sales record database 120. For example, a user may use web server/application server module 110 to request an equipment price index for a specific make and model of a machine. The user may also specify the time periods for the requested equipment price index. A time period may be any defined duration of time, such as a week, a month, a quarter, a year, etc. For example, the user may specify that the equipment price index be generated for the ten quarters from the third quarter of 2002 to the fourth quarter of 2004. Equipment price management system 130 may then access and process auction sales data records for the requested equipment stored in sales record database 120 and generate an equipment price index for the equipment based on sales data records with sales completion dates in the ten quarters. The equipment price index generated by equipment price management system 130 may show the make and model of the requested equipment, and the equipment price index data points for each of the requested ten quarters.

Network 140 may be any type of communication network that transfers data, such as the Internet, a wireless or wireline local area network (LAN), or another type of network. Network 140 is intended in its broadest sense to encompass any communication system that uses any type of medium to transfer data.

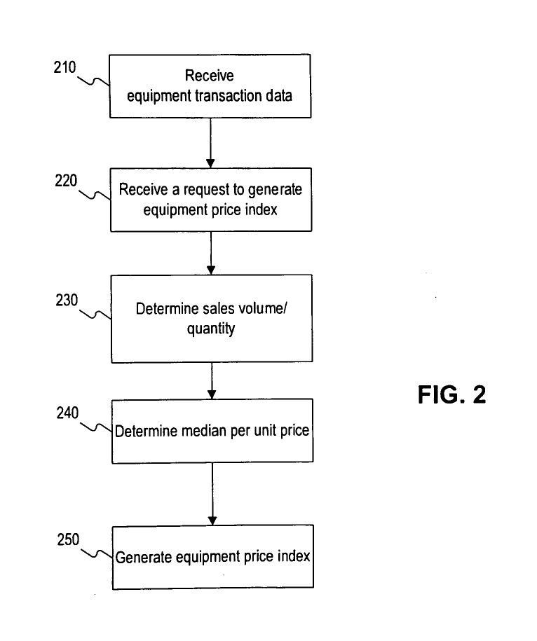

FIG. 2 is a flow chart of exemplary steps for generating an equipment price index. First, equipment price management system 130 may receive transaction data such as auction and sales data from equipment auctions and equipment dealerships (step 210). A transaction data record may include transaction information for a piece of equipment sold or auctioned, such as the make, model, age, and price. For example, equipment price management system 130 may receive auction sales data for equipment A. These transaction data records may be sent to equipment price management system 130 from, for example, a dealership, an auction organizer, or any other services that may maintain equipment sales data records. The transaction data record may include data reflecting equipment age, sales price, date of sale, etc. Equipment price management system 130 may receive transaction data records for different types of equipment and from various data sources. Further, equipment price management system 130 may store the transaction data records in a database, such as sales record database 120.

Equipment price management system 130 may also receive a request to generate an equipment price index (step 220). In one embodiment, a user may issue the request and specify the make and the model of the requested equipment. The user may also request an equipment price index to be generated through web server/application server module 110. The request may also specify the one or more time periods for generating the requested equipment price index. For example, a user may request the equipment price index for six machines, equipment A, B, C, D, E, and F, for the ten quarters from the third quarter of 2002 to the fourth quarter of 2004. The user may further request that the equipment price index be based on auction sales data for the requested equipment.

Based on the request for the equipment price index, equipment price management system 130 may search sales record database 120 to retrieve auction sales data records related to the requested equipment. Equipment price management system 130 may determine the sales volume for the requested equipment for each time period of the index (step 230). Referring back to the above example, equipment price management system 130 may retrieve all relevant auction sales data records for equipment A, B, C, D, E, and F from sales records database 120, and then determine the sales volume for equipment A, B, C, D, E, and F for each of the requested ten quarters.

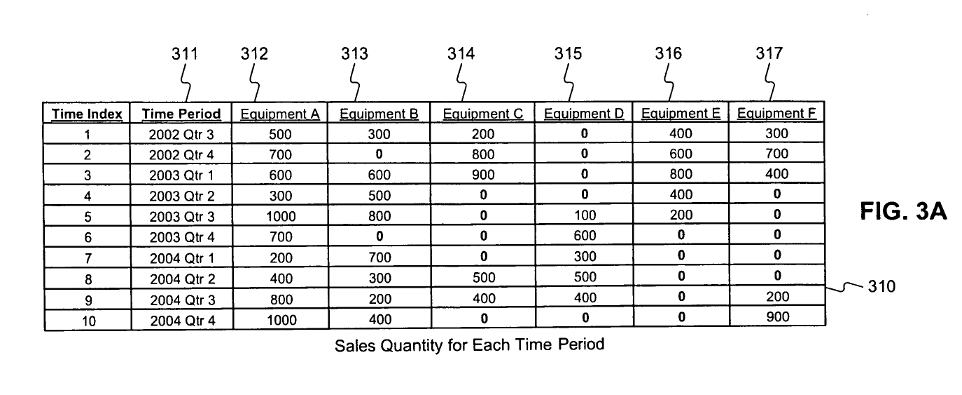

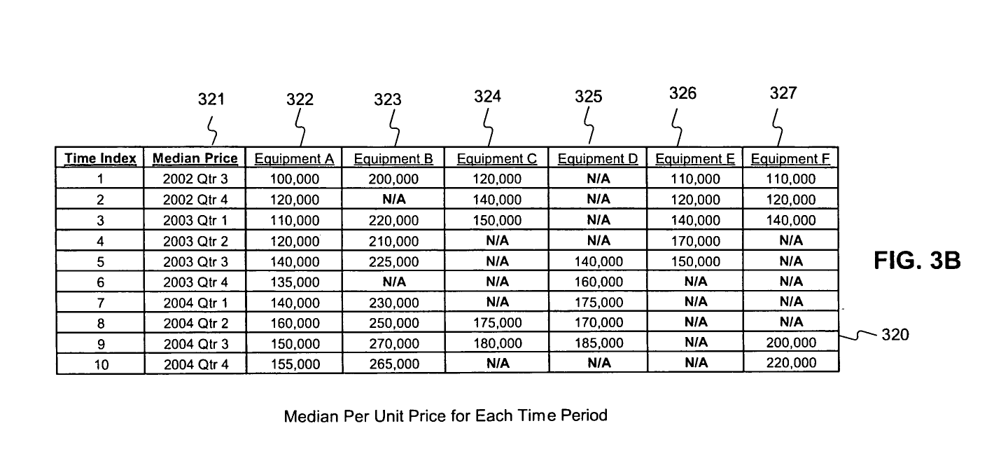

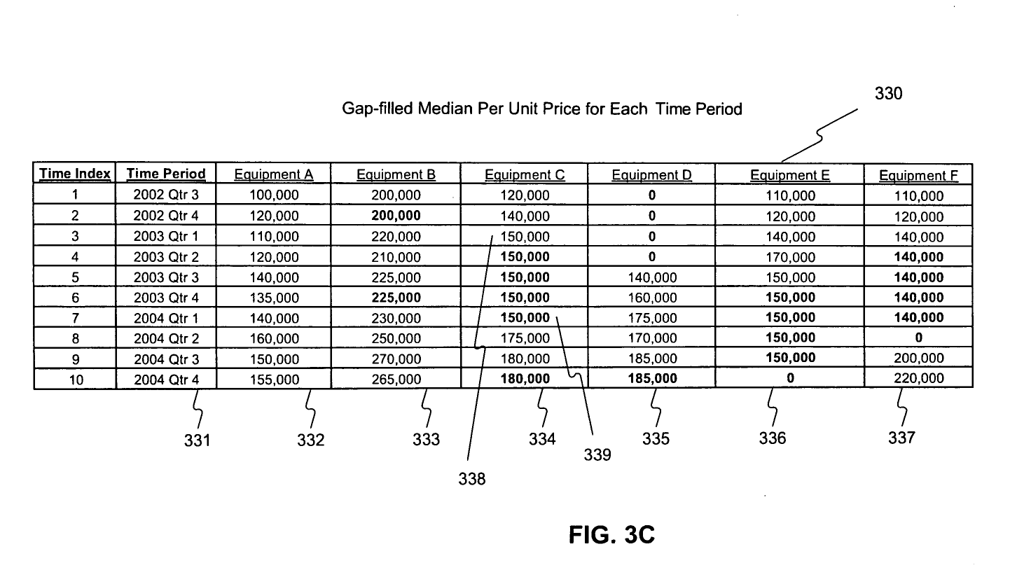

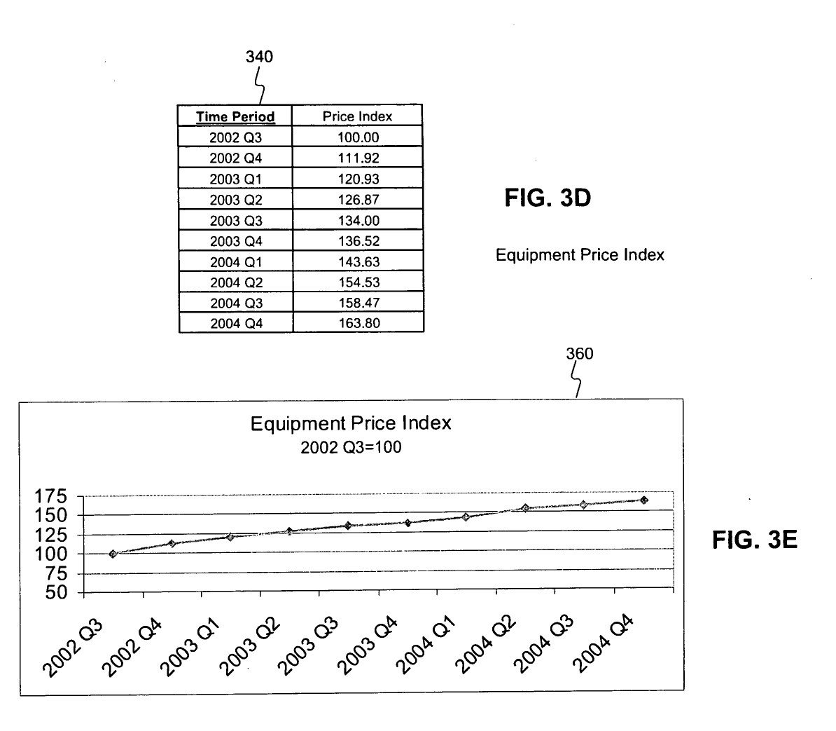

FIGS. 3A-3E show exemplary tables including data reflecting the results of calculating the equipment price index based on the auction sales data for the above example. FIG. 3A shows a table 310 including data reflecting quantities of equipment A, B, C, D, E, and F sold for each quarter from the third quarter of 2002 to the fourth quarter of 2004. Column 311 lists the time periods (e.g., the ten quarters) of the requested equipment price index. Columns 312, 313, 314, 315, 316, and 317 list the volumes of sales for equipment A, B, C, D, E, and F, respectively, for the ten quarters. For example, as shown in FIG. 3A, in the third quarter of 2002, 500 pieces of equipment A were sold; 300 pieces of equipment B were sold; and 200 pieces of equipment C were sold, etc.

In FIG. 3A, equipment A was traded consistently through the ten quarters. Equipment B, C, D, E, and F were not traded in all of the ten quarters. Equipment B was traded in most of the ten quarters with gaps (no sales) in the fourth quarter of 2002 and the fourth quarter of 2003 as shown in column 313. Equipment C was traded in five of the ten quarters as shown in column 314. As shown in column 315, equipment D was not traded in the first four quarters listed. Equipment D was traded for the five subsequent quarters from the third quarter of 2003 to the third quarter of 2004, and then not traded (gap) in the fourth quarter of 2004. As shown in column 316, equipment E was not traded (e.g., leaves the market) in the quarters after the third quarter of 2003. Equipment F was traded during the first three quarters as shown in column 317, not traded from the second quarter of 2003 to the second quarter of 2004, and then traded again in the third quarter of 2004 after five consecutive quarters of sales inactivity.

Equipment price management system 130 may retrieve real transaction data (auction or sales data) to determine an equipment price index. Use of market transaction data allows equipment price management system 130 to determine the equipment price index based on market price. However, because not all items are traded in every tracked time period, there often may be data gaps as described above in columns 313-317 of FIG. 3A. When a “data gap” exists, quantity sold is shown as zero (0) in FIG. 3A. Since no transaction occurred, the median price as shown in FIG. 3B may be defined as not available (N/A). Equipment price management system 130 may apply various algorithms to process real auction or sales data to populate gap data fields before calculating an equipment price index (“gap-filling”).

For example equipment price management system 130 may fill a gap in transaction data by retaining the last time period's median transaction price. FIG. 3C shows a table 330 including data reflecting median prices of equipment A, B, C, D, E, and F sold for each quarter of the year after equipment price management system 130 performed an exemplary gap-filling process. FIG. 3C will be explained later in relation to FIG. 3B.

Returning to FIG. 2, for each time period of the index, equipment price management system 130 may determine the median per unit sales prices for the requested equipment (step 240). Equipment price management system 130 may determine the median per unit price for each requested equipment based on the retrieved sales data records. Equipment price management system 130 may implement any type of algorithm, technique, etc. to determine the median per unit price. For example, referring back to the above example, FIG. 3B shows an exemplary table 320 including data reflecting the median prices for the requested equipment for each time period. Column 321 lists the time periods of the requested equipment price index. Columns 322, 323, 324, 325, 326, and 327 list the median auction sales prices for equipment A, B, C, D, E, and F in each time period, respectively. As shown in FIG. 3B, in the third quarter of 2002, the median sales price for equipment A was $100,000; the median sales price for equipment B was $200,000; the median sales price for equipment C was $120,000, etc.

Different factors may affect the equipment sales price. For example, the exemplary equipment A, B, C, D, E, and F may have different sales prices in different time periods. As shown in FIG. 3B, equipment A has a median sales price of $120,000 in the fourth quarter of 2002. However, equipment A has a median sales price of $110,000 in the next quarter, the first quarter of 2003. These kinds of price fluctuations may be caused by changes in the supply of and demand for equipment as well as many other factors related to market conditions. Accordingly, equipment price management system 130 calculates the equipment price index using median sales prices in each time period to reduce the bias of outlier sales prices that may be caused by certain short-term market conditions (e.g., urgent need of a large construction project, natural disaster, etc.). In another embodiment, a user may vary the choice of the time periods (e.g., quarters, years, multiple years) to further reduce the impact of outlier transaction prices on the equipment price index calculation.

Further, as discussed earlier, equipment price management system 130 may perform a gap-filling function after receiving market transaction data, such as median auction sales prices for equipment A, B, C, D, E, and F, as shown in FIG. 3B. Equipment price management system 130 may apply various algorithms and techniques (e.g., using an average or a weighted average of median prices over certain time periods) when performing the gap-filling function.

In one embodiment, equipment price management system 130 may populate sales data for a gap time period (time period t) by replicating the sales price data from its previous time period (time period t-1). If the previous period (time period t-1) contains no sales data, equipment price management system 130 may check whether the next time period (time period t-2) contains sales data. Equipment price management system 130 may repeat this process for a predetermined number of times (e.g., five times). FIG. 3C shows the sales data of FIG. 3B after equipment price management system 130 performs the gap-filling function. Column 331 lists the time periods of the requested equipment price index. Columns 332, 333, 334, 335, 336, and 337 list the processed median auction sales prices for equipment A, B, C, D, E, and F, in each time period, respectively.

For example, as shown in FIG. 3B, column 324, equipment price management system 130 has not received sales data for equipment C for the first quarter of 2004 (time period t). To populate sales data for equipment C for the first quarter of 2004, equipment price management system 130 may first check the sales data of the previous time period, i.e., the fourth quarter of 2003 (time period t-1), and determine that there is no sales data for the fourth quarter of 2003 (FIG. 3B, column 324). Equipment price management system 130 may then check the sales data from the next time period, the third quarter of 2003 (time period t-2), and determine that there is no sales data for the quarter (FIG. 3B, column 324). In this example, equipment price management system 130 may repeat the process of checking for the previous quarter's sales data for a predetermined number of times (e.g., four times). Equipment price management system 130 may find that the fourth quarter back from the first quarter of 2004 (time period t-4), the first quarter of 2003, contains sales data 338 for equipment C, as shown in FIG. 3C, column 334. Equipment price management system 130 may then populate sales data 339 for equipment C for the first quarter of 2004 by replicating the sales data 338 from the first quarter of 2003. As shown in FIG. 3C, column 334, equipment price management system 130 may repeat this process and populate the sales data fields for the fourth quarter of 2003, the third quarter of 2003 and the second quarter of 2003. In the example shown in FIG. 3C, equipment price management system 130 performs the gap-filling process by checking the past four time periods. For equipment E, as shown in column 326 of FIG. 3B, there were no sales data for the five quarters from the fourth quarter of 2003 to the fourth quarter of 2004. To determine whether to replicate sales data (gap-filling) for the fourth quarter of 2004 (time period t), equipment price management system 130 may check sales data received for the previous four quarters (from the third quarter of 2004 to the fourth quarter of 2003). As shown in column 326 of FIG. 3B, equipment price management system 130 received no sales data for any of the four previous quarters (time periods t-1, t-2, t-3, and t-4). Equipment price management system 130 may then populate price data for the fourth quarter of 2004 with a gap-filling equipment price of 0, as shown in FIG. 3C, column 336.

Referring back to FIG. 2, based on the determined information, equipment price management system 130 may generate an equipment price index (step 250). Equipment price management system 130 may generate the equipment price index by calculating the relative equipment price measurement (i.e., an equipment price index data point) for each time period. In one embodiment, the equipment price index (Y) for time period t may be determined by the following equation where t=1, 2, 3, 4, . . . and Yₜ=100 when t=1:

$${Y}_{t} = \sqrt{\frac{\sum {P}_{t} {Q}_{t - 1}}{\sum {P}_{t - 1} {Q}_{t - 1}} \times \frac{\sum {P}_{t} {Q}_{t}}{\sum {P}_{t - 1} {Q}_{t}}} \times {Y}_{t - 1}$$

Yₜ is the equipment price index for time period t. For the first time period (i.e., t=1), Yₜ may be set to a specified value, such as 100. Qₜ is the quantity of sales (i.e., volume of sales) for time period t, and Qₜ₋₁ is the quantity of sales for time period t-1. Pₜ is the median sales price (after the gap-filling process) for time period t, and Pₜ₋₁ is the median sales price (after the gap-filling process) for time period t-1. When calculating the index for time period t, ΣPQ is the sum of the product of the median prices and the sales quantities for each type of requested equipment included in the equipment price index for which (after the gap-filling process) Pₜ is non-zero and Pₜ₋₁ is non-zero. Referring back to the above example shown in FIGS. 3A and 3C, for the third quarter of 2002 (i.e., t=1), Yₜ (i.e., Y₁) is set to 100. For the fourth quarter of 2002 (i.e., t=2), the equipment price index may be calculated as follows:

$$\begin{matrix}{Y}_{2} = \sqrt{\frac{\sum {P}_{2} {Q}_{1}}{\sum {P}_{1} {Q}_{1}} \times \frac{\sum {P}_{2} {Q}_{2}}{\sum {P}_{1} {Q}_{2}}} \times {Y}_{1} \\ = \sqrt{\frac{\begin{matrix}120000 \cdot 500 + 200000 \cdot 300 + 140000 \cdot \\ 200 + 120000 \cdot 400 + 120000 \cdot 300\end{matrix}}{\begin{matrix}100000 \cdot 500 + 200000 \cdot 300 + 120000 \cdot \\ 200 + 110000 \cdot 400 + 110000 \cdot 300\end{matrix}}} \times \\ \sqrt{\frac{\begin{matrix}120000 \cdot 700 + 200000 \cdot 0 + 140000 \cdot \\ 800 + 120000 \cdot 600 + 120000 \cdot 300\end{matrix}}{\begin{matrix}120000 \cdot 700 + 200000 \cdot 0 + 140000 \cdot \\ 800 + 110000 \cdot 600 + 110000 \cdot 700\end{matrix}}} \times 100 \\ = 111.92\end{matrix}$$

### Therefore, Y₂ for the fourth quarter of 2002 is 111.92. Similarly, Y₃ is calculated for the first quarter of 2003:

$${Y}_{3} = \sqrt{\frac{\sum {P}_{3} {Q}_{2}}{\sum {P}_{2} {Q}_{2}} \times \frac{\sum {P}_{3} {Q}_{3}}{\sum {P}_{2} {Q}_{3}}} \times - {Y}_{2} = - 120.93$$

Equipment price management system 130 may store the value of the determined equipment price indices in a data structure, even as a table, array, etc. For example, FIG. 3D shows table 340 reflecting the values of the equipment price indices for the rest of the requested quarters in 2003 and 2004.

As the relative price of certain equipment falls, buyers may substitute or update their current inventory with cheaper equipment. If an equipment price index were calculated using a fixed-weight method (e.g., using the base time period index as the weight for all time periods), the drop in price would be underweighted for the time periods beyond the base period. As shown above, for a given quarter, the equipment price index is chain-weighted based on sales quantities of the current quarter and the previous quarter, and the median sales prices. The chain-weighted equipment price index would therefore lessen the bias caused by buyers shifting their buying patterns in response to equipment price changes.

Equipment price management system 130 may generate data for presenting the equipment price index to the user. For instance, equipment price management system 130 may format the equipment price index data and provide the formatted data to web server/application server 110 for display to the user via a user interface. FIGS. 3D and 3E show exemplary equipment price index representations that may be presented to a user. As shown in FIG. 3D, equipment price index table 340 may present the equipment price index across the ten requested quarters. For example, table 340 shows an exemplary equipment price index for equipment A, B, C, D, E, and F for the ten quarters from 2002 to 2004. Alternatively, or additionally, the equipment price index of 340 may be shown as a graph 360 with the equipment price index data points as shown in FIG. 3E. It should be noted that the disclosed embodiments may present equipment price index information in any format, and the examples described above and shown in FIGS. 3D and 3E are not intended to be limiting. Any type of report (e.g., text, graphs, et.) may be generated to present an equipment price index to a user or a software process.

### INDUSTRIAL APPLICABILITY

Methods and systems consistent with the disclosed embodiments enable users to accurately view equipment price performance. The chain-weighted equipment price index may help a user or software process assess past and current market conditions. Additionally, the chain-weighted equipment price index provides users a more accurate view of the equipment price trends over time.

Methods and systems consistent with the disclosed embodiments also enable users to switch the time periods of the chain-weighted equipment price index without the need to recalculate the index. As shown above, the equipment price index for a given time period is determined based on the median sales prices and quantities of the given time period and the previous time period. Thus, there is no need to revise the equipment price index when the base time period is changed.

Further, methods and systems consistent with the disclosed embodiments enable users to accurately track and compare equipment price performance for different manufacturers, different market segments and different geographic regions. For example, a dealership may compare the equipment price indexes of two competing models when planning and managing their inventories.

Additionally, methods and systems consistent with the disclosed embodiments enable users to simulate “what if” scenarios when making business decisions. For example, when a business manager is planning for future equipment productions, she can load sales record database 120 with simulated sales data and study the equipment price index to assess various business strategies and future equipment price performance.

Accordingly, the disclosed embodiments provide an equipment price index for managing an), type of business assessment related to the equipment identified in the request and maintained in equipment sales records, etc. Business assessments are not limited to any of the examples disclosed above and may include any type of assessment for marketing, sales, inventory, management purposes, etc. Further, business assessments may be performed by a user or a software process executed by a processor (e.g., equipment price management system 130), such as an artificial intelligence engine, expert systems, etc.

It will be apparent to those skilled in the art that various modifications and variations can be made in the disclosed armature assembly without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims.

What is claimed is:

1. A method for generating an equipment price index, the method including:
receiving equipment sales records;
determining, based on the equipment sales records, a first equipment quantity for a first time period and a second equipment quantity for a second time period;
determining a first median price of the first equipment quantity for the first time period and a second median price of the second equipment quantity for the second time period;
determining the equipment price index based on the first and second equipment quantities and the first and the second median prices; and
providing the equipment price index for an assessment related to equipment associated with the equipment sales records.

2. The method of claim 1, wherein the second time period is a sequential time period of the first time period.

3. The method of claim 2, further including:
assigning the determined price index to the second time period.

4. The method of claim 1, further including:
receiving a request to generate the equipment price index, the request identifying a set of equipment and a set of time periods including the first and the second time periods.

5. The method of claim 1, further including:
receiving equipment sales transaction data reflecting a sales price, a sales completion date, and features associated with a sales transaction of a piece of equipment.

6. The method of claim 3, further including:
determining the equipment price index for the second time period by calculating weights of a price change based on the first and second equipment quantities.

7. The method of claim 6, further including:
displaying the equipment price index in a graphical format.

8. A system for generating an equipment price index, the system including:
a processor; and
a memory storing data including equipment sales records, wherein the processor is configured to:
receive equipment sales records;
determine a first equipment quantity for a first time period, and a second equipment quantity for a second time period;
determine a first median price of the first equipment quantity for the first time period and a second median price of the second equipment quantity for the second time period;
determine the equipment price index based on the first and second equipment quantities, and the first and the second median prices; and
provide the equipment price index for an assessment related to equipment associated with equipment sales records.

9. The method of claim 8, wherein the second time period is a sequential time period of the first time period.

10. The system of claim 9, wherein the processor is further configured to:
assign the determined price index to the second time period.

11. The system of claim 8, wherein the processor is further configured to:
receive a request to generate the equipment price index, the request identifying a set of equipment and a set of time periods including the first and the second time periods.

12. The system of claim 8, wherein the processor is further configured to:
receive equipment sales transaction data reflecting a sales price, a sales completion date, and features associated with sales transactions of a piece of equipment.

13. The system of claim 11, wherein the processor is further configured to:
determine the equipment price index for the second time period by calculating weights of a price change based on the first and second equipment quantities.

14. The system of claim 13, wherein the processor is further configured to:
provide data for displaying the equipment price index in a graphical format.

15. A computer-readable medium containing instructions to configure a processor to perform a method for generating an equipment price index, the method including:
receiving equipment sales records;
determining a first equipment quantity for a first time period and a second equipment quantity for a second time period;
determining a first median price of the first equipment for the first time period and a second median price of the second equipment quantity for the second time period;
determining the equipment price index based on the first and second equipment quantities, and the first and the second median prices; and
providing an equipment price index for an assessment related to equipment associated with the equipment sales records.

16. The method of claim 15, wherein the second time period is a sequential time period of the first time period.

17. The method of claim 15, further including:
receiving a request to generate the equipment price index, the request identifying a set of equipment and a set of time periods including the first and the second time periods.

18. The method of claim 15, further including:
receiving equipment sales transaction data reflecting a sales price, a sales completion date, and features associated with sales transactions of a piece of equipment.

19. The method of claim 17, further including:
determining the equipment price index for the second time period by calculating weights of a price change based on the first and second equipment quantities.

20. The method of claim 15, further including:
displaying the equipment price index in a graphical format.
